(19) United States
(12) Patent Application Publication
(10) Pub. No.: US 2020/0256125 A1
(43) Pub. Date: Aug. 13, 2020

(54) RESCUE LADDER ATTACHMENT

(71) Applicant: Ross Hoffmann, Prospect, KY (US)

(72) Inventor: Ross Hoffmann, Prospect, KY (US)

(21) Appl. No.: 16/662,926

(22) Filed: Oct. 24, 2019

Related U.S. Application Data
(63) Continuation-in-part of application No. 16/275,196, filed on Feb. 13, 2019.

(51) Int. Cl. E06C 1/10; E06C 1/32; E06C 7/08

(52) U.S. Cl. CPC E06C 1/10; E06C 7/086; E06C 1/32

(57) ABSTRACT

An attachment for a ladder includes a pair of rung tubes for engaging the hollow rungs of a ladder secured together by at least one end tube.

### BACKGROUND OF THE INVENTION

### Field of the Invention

The present invention relates generally to an apparatus for converting a conventional ladder into an emergency rescue ladder. The apparatus described is a removable ladder attachment that secures quickly to a conventional ladder and provides a hinged extension that may be positioned in a break or hole in a semi-frozen body of water to aid in rescue operations.

### Description of the Related Art

In rescue events where a person or animal has fallen through the ice surface of a semi-frozen body of water it is often impossible for a rescuer to place much weight on the unstable ice surface, thus making it difficult to reach a person who has fallen through the ice. Obviously, time is of the essence in in these situations, since hypothermia and the attendant loss of motor and cognitive function set in quickly as body temperature plummets.

Various devices have been developed and used to assist in ice-breakthrough rescues, including various rope devices and ladders. The use of a rescue ladder offers some advantages, since the ladder provides a pair of opposed side rails that distribute weight across a width of the ice surface and can easily be slid towards the ice break from a distance. Once the ladder has been extended to the break area, the person being rescued need only hold on to a ladder rung and the rescuers can then pull the ladder back towards a more stable section of ice, or the shoreline.

The use of a conventional ladder in ice rescues does suffer from several disadvantages however. In some instances the person being rescued may not be capable of holding onto a ladder rung tightly enough to be pulled out of the water as the ladder is retracted by rescuers. Furthermore, in some instances it is desirable to be able to lower a portion of the ladder into the hole caused by the break in the ice, so that a victim can place his or her feet on a rung and thus be pulled out of the water to safety. However, with conventional ladders that simply lay flat on the ice surface this is impossible.

Accordingly, there is a need in the art for an apparatus to be used in conjunction with a ladder to assist in ice-breakthrough rescue operations that is quick to assemble, readily deployed, and capable of being lowered or placed at least partially in the water to enable a victim to grasp the rescue apparatus.

### SUMMARY OF THE INVENTION

The present disclosure is related to an apparatus for providing a ladder attachment that converts a conventional ladder to a rescue ladder. The system described herein provides a ladder attachment that is wider than the width of the ladder to which it is attached. The ladder attachment may include a pair of spaced apart side rails that are secured together by at least one rung.

In various embodiments, the system disclosed herein provides an attachment that includes at least one end having a removable rung or pin that slides through two opposed apertures in the side rails of the attachment. This removable rung acts as a hinge when the attachment is secured to a conventional ladder by aligning the opposed apertures with the end rung of a conventional ladder and then inserting the removable pin through the cylindrical rung. This feature of the system enables a rescuer or rescue team to rapidly deploy the ladder attachment, quickly securing it to a longer ladder for emergency use.

In some embodiments and aspects both ends of the attachment may include a removable pin. In these embodiments the attachment may be used to secure two ladders together as needed. In other aspects and embodiments one end of the attachment may include a step or foothold to assist a person being rescued whereby the step end of the attachment may be placed in the water.

In various implementations set forth, a removable ladder attachment for use with a ladder of predetermined size having at least one hollow rung is described. The removable ladder attachment may have a first and a second side rail having a plurality of rungs extending between the first and the second side rail, wherein the plurality of rungs separate the first and the second side rail by a first predetermined width. The removable latter may also have a first aperture formed in the first side rail and a second aperture formed in the second side rail substantially opposing the first aperture. The removable ladder may also include a removable rung insertable through the first aperture and the second aperture and extending between the first side rail and the second side rail wherein a first end of the removable rung is extends beyond the first rail and a second end of the removable run extends beyond the second rail. In some implementations, the first predetermined width of the removable ladder attachment is greater than a second predetermined width of the ladder of predetermined size having at least one hollow rung to which the removable ladder is to be pivotally attached. In further implementations, the removable rung is sized to extend through the at least one hollow rung of the ladder of predetermined size and through the first and the second aperture of the removable ladder and be releasably locked in place.

In some aspects and embodiments a universal apparatus for securing a pair of rescue ladders together is provided. In these embodiments a pair of end clamps operate to secure a pair of rods that engage hollow ladder rungs, thereby connecting the end rungs of two different ladders together. In some further embodiments the apparatus may include a pair of foldable legs that are secured on a single end by a clamp. By utilizing a simple, lightweight, and readily assembled apparatus for securing two ladders together, a rescue crew can rapidly connect and deploy a pair of ladders for use in an ice or water rescue emergency.

In some additional embodiments two pairs of opposed spring-loaded clamps may be provided to secure adjacent rungs of two ladders together, thereby providing for rapid attachment and disassembly.

The term “ladder” as used herein includes any type of ladder having a rung or rungs that are cylindrically and hollow so that the removable rung or pin of the attachment may be positioned there through.

It should be appreciated that all combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other features, objects and advantages of the present invention will become apparent from the detailed description of the drawing Figures taken in conjunction with the appended drawing Figures.

### BRIEF DESCRIPTION OF THE DRAWING FIGURES

In the drawings, like reference characters generally refer to the same parts throughout the different views. The drawings are not necessarily to scale. Emphasis is instead generally placed upon illustrating the principles of the disclosure, wherein;

FIG. 1 is a perspective view of a ladder attachment in accordance with one embodiment of the present invention;

FIG. 2 is a perspective view of a ladder attachment being secured to a standard ladder in accordance with one embodiment of the present invention;

FIG. 3 is a perspective view of a ladder attachment in accordance with one embodiment of the present invention;

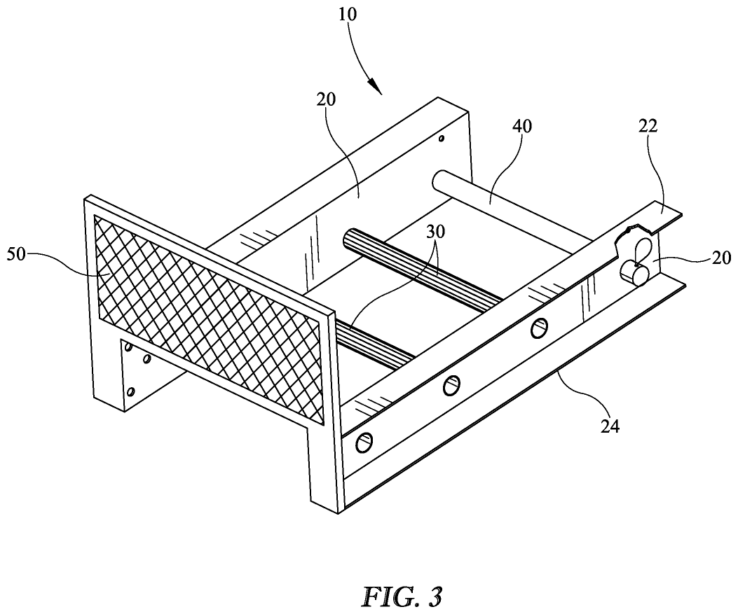

FIG. 4 is a partial perspective view of a ladder attachment and ladder being used in a rescue operation in accordance with one embodiment of the present invention;

FIG. 5 is a perspective view of a ladder attachment being used to join two standard ladders in accordance with one embodiment of the present invention; and

FIG. 6 is a perspective view of a ladder attachment being used to join two standard ladders in accordance with one embodiment of the present invention;

FIG. 7 is a perspective view of a ladder attachment being used to join two standard ladders in accordance with one embodiment of the present invention;

FIG. 8 is a perspective view of a ladder attachment being used to join two standard ladders in accordance with one embodiment of the present invention;

FIG. 9 is a perspective view of a ladder attachment being used to join two standard ladders in accordance with one embodiment of the present invention;

FIG. 10 is a perspective view of a ladder attachment apparatus in accordance with one embodiment of the present invention;

FIG. 11 is a perspective view of a ladder attachment apparatus in accordance with one embodiment of the present invention;

FIG. 12 is a perspective view of a ladder attachment apparatus in accordance with one embodiment of the present invention; and

FIG. 13 is a perspective view of a ladder attachment being used to join two standard ladders in accordance with one embodiment of the present invention.

### DETAILED DESCRIPTION OF THE PREFERRED EMBODIMENT(S)

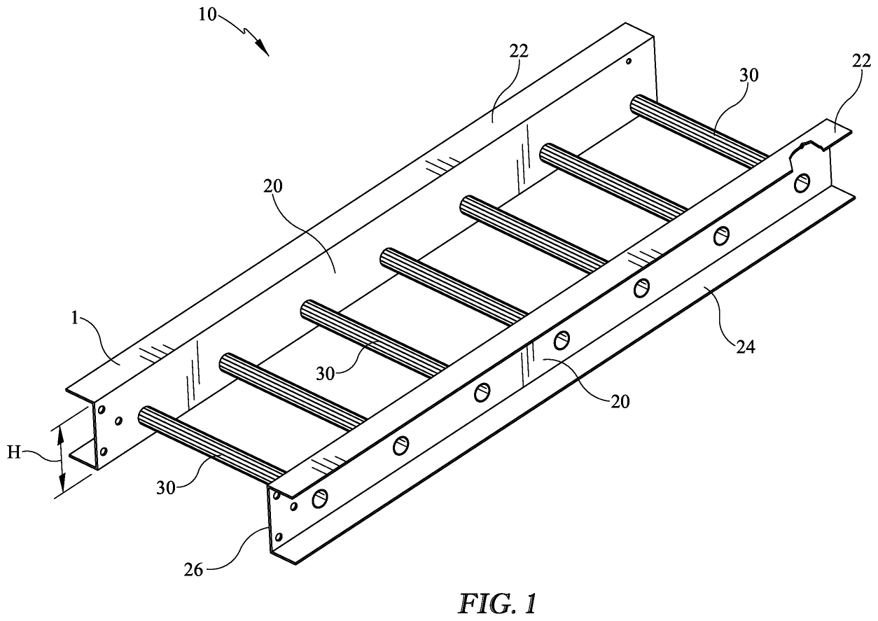

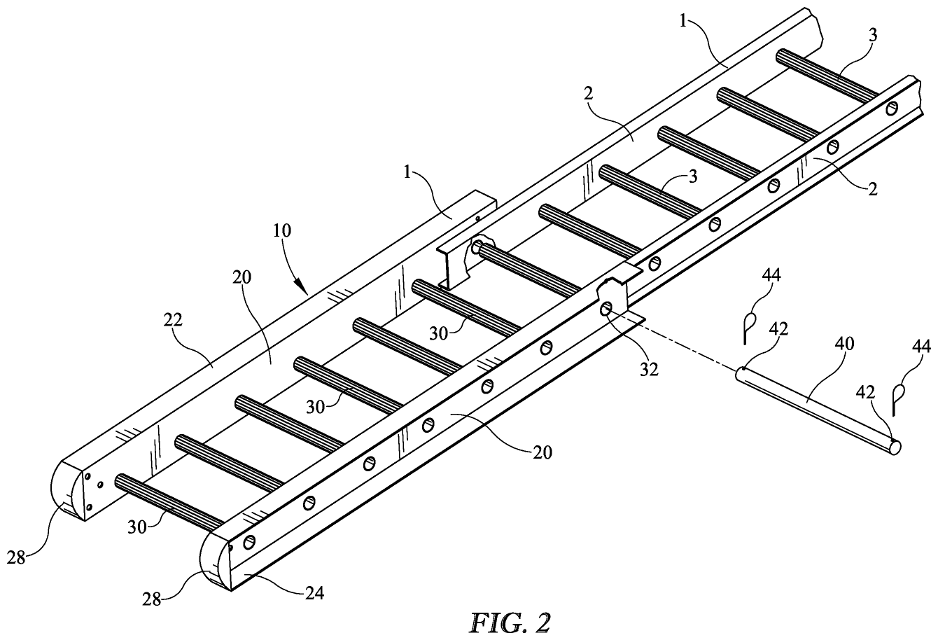

Referring now to drawing FIGS. 1 and 2, and in accordance with various embodiments of the invention, the system described herein overcomes the aforementioned difficulties in the prior art by providing a ladder attachment apparatus 10 for facilitating ice-breakthrough rescue. In various aspects of the invention, the attachment apparatus 10 is constructed to be used in conjunction with a conventional ladder 1 of predetermined size. Ladder 1 may include a pair of spaced side rails 2 separated by a plurality of rungs 3. In various aspects ladder 1 rungs 3 are typically shaped as hollow cylinders, whereby a pin or rod may be inserted into and through rungs 3, as will be discussed further herein below.

In some embodiments ladder 1 is constructed to have a conventional spacing between rails 2, for example 12 or 16 inches, although one of ordinary skill will understand that a wide variety of ladder 1 rail 2 spacings are capable of being employed in conjunction with attachment apparatus 10 without departing from the scope of the invention. Furthermore a ladder or ladders 1 used in conjunction with apparatus 10 may have any length and still be capable of being utilized with apparatus 10. It should be noted that commercial emergency and residential use ladders are typically manufactured in compliance with safety and sizing standards set by the Occupational Safety and Health Administration (OSHA) as well as the American Ladder Institute (ALI). The invention disclosed herein is, in some embodiments, intended to be operable with a many of the ladders 1 manufactured according to these standards, but it should be understood that the invention is not limited to use with ladders 1 manufactured in such a fashion

In various embodiments attachment apparatus 10 is constructed of a pair of spaced, generally parallel side rails 20 secured together by at least one rung 30. Side rails 20 may be constructed to have top 22 and bottom 24 flanges that extend outwardly away from rails 20, thereby providing a surface along which attachment 10 may slide during use. Top and bottom flanges 22, 24 may be produced in a variety of widths. For example, in some embodiments a three inch wide top and bottom flange 22, 24 may be employed to facilitate sliding across ice 5 and further to increase the surface area over which weight is distributed when a person being rescued is being pulled to safety, thereby reducing the possibility of additional breakthroughs.

In some exemplary embodiments top flange 22 and bottom flange 24 may terminate at either end 26 of attachment 10 in a curved or chamfered edge 28, thereby enabling attachment 10 to slide or glide along an ice 5 surface without digging in or causing undue resistance. Furthermore, spaced side rails 20 are spaced apart to be slightly wider than the ladder 1 to which attachment 10 is being secured, so that side rails 20 can be positioned outside the rails of a conventional ladder 1, as will be discussed further herein below.

In some embodiments depicted in FIGS. 1, 2 and 5, ladder attachment 10 includes a removable rung or pin 40, or alternatively a pair of removable pins 40 at either end, one at each end of attachment 10. Removable pin 40 may include an aperture 42 at each end thereof, to accept a cotter pin 44 or similar fastener. Side rails 20 of attachment 10 may include at least one pair of opposed apertures 32 through which removable pin 40 may be inserted. When ladder attachment 10 is not in use, removable pin 40 is simply inserted through apertures 32 and secured in place with a removable pin 44 or similar fastener. Removably fastening rung or pin 40 into the apertures of the ladder attachment 10 may be accomplished through other fastening structures instead of a cotter pin 44. For example, spring loaded depression buttons may be formed in the rung 40 in place of the apertures 42 which would lock the rung/pin 40 in position at either end. Other types of fasteners may be utilized to allow the rung 40 to be removed from an attached configuration affixing the ladder attachment 10 to the ladder 1 and within rung 3.

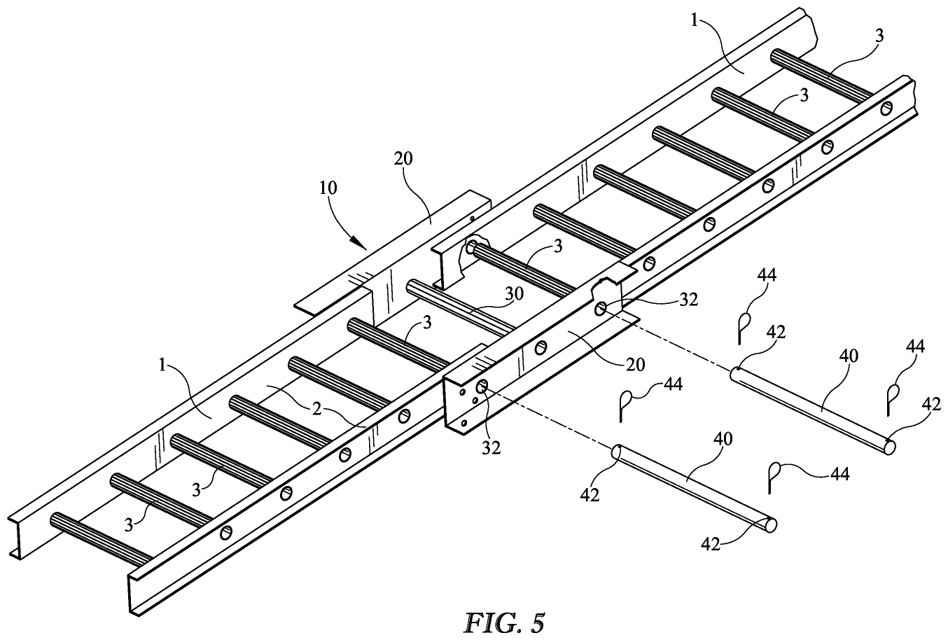

As best seen in FIG. 5 the removable attachment 10 may be removably secured to ladder 1 by removing pins 44 from the rung/pin 40 of the attachment 10, positioning side rails 20 of attachment outside an end rung 3 of ladder 1, aligning apertures 32 with the end rung 3 and then sliding removable pin 40 through the hollow end rung 3. Once through, removable pin 40 can be removably secured by inserting a cotter pin 44 through the apertures 42 and either end thereof. In some embodiments removable pin 40 may be replaced with a collapsible cylindrical rung 40 that is capable of sliding through apertures 32.

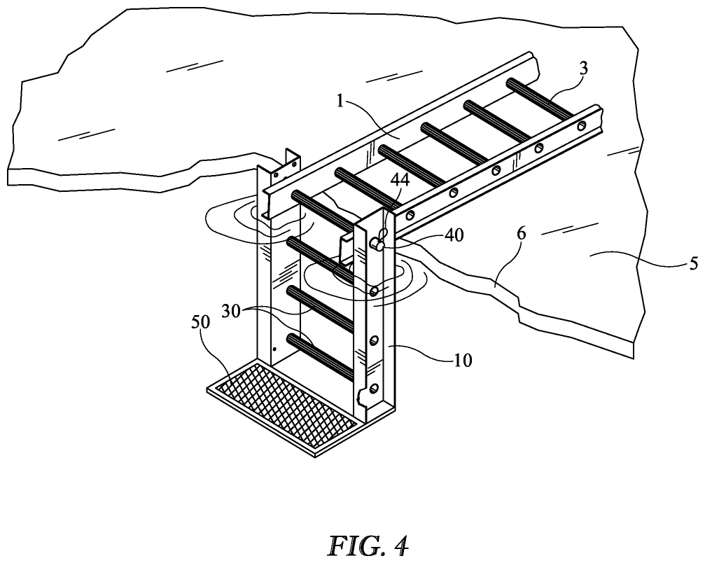

Once secured as described herein above and as depicted in FIG. 4, ladder attachment 10 is capable of being positioned in a break or hole 6 in an ice surface 5 by simply sliding ladder 1 toward the hole 6, and then letting attachment 10 slide into the hole 6. Since attachment 10 is secured to ladder 1 by a pin 40 through the hollow ladder rung 3, attachment 10 is free to pivot around the central axis of pin 40, thereby allowing attachment 10 to slide down into hole 6 to be grasped or stood on by a person being rescued. In some embodiments, where attachment 10 is constructed to be relatively short from end to end, it may be easily lowered into even a small hole 6 or break in the ice 5. In a yet further embodiment in of the invention, one end of attachment 10 may be provided with a step 50 that extends outwardly to facilitate standing by a person being rescued. Step 50 may be constructed as a grate or other non-slip surface to enhance traction. In these embodiments the step 50 is positioned away from the ladder 1 to which attachment 10 is being secured so that it enters the hole 6 first when attachment is properly positioned.

In some aspects and embodiments of the invention, and as best depicted in FIG. 5, ladder attachment 10 may include two removable rungs 40, one at each end thereof, positioned in two pairs of opposed apertures 32 respectively. In these embodiments, attachment 10 may be used to quickly secure two ladders 1 together where a longer length is need to reach someone in a rescue situation. Each rung 40 is inserted through an aperture of end rung 3 of one of the ladders 1 and then secured in place, thereby providing a rescuer a very quick and simple system for securing two ladders together. Furthermore, in some embodiments, attachment 10 may include a removable rung 40 at each end and just a single rung 30, thereby providing a compact and easy to store ladder attachment 10 for ice rescues. This embodiment of the invention is advantageous since the space needed to store the attachment 10 is minimal and can be accommodated by most fire trucks and emergency response vehicles.

It should be noted that ladder attachment apparatus 10 may be constructed of any conventional material that is commonly used for a conventional ladder, such as fiberglass, aluminum, steel, or even wood without departing from the scope of the invention. Furthermore, attachment 10 may be constructed in a wide variety of sizes. Spaced rails 20 need only be slightly wider than the ladder 1 to which the attachment is being secured. Additionally, attachment 10 may include a plurality of rungs 30, or just one rung 30 depending on the space and storage needs of the user.

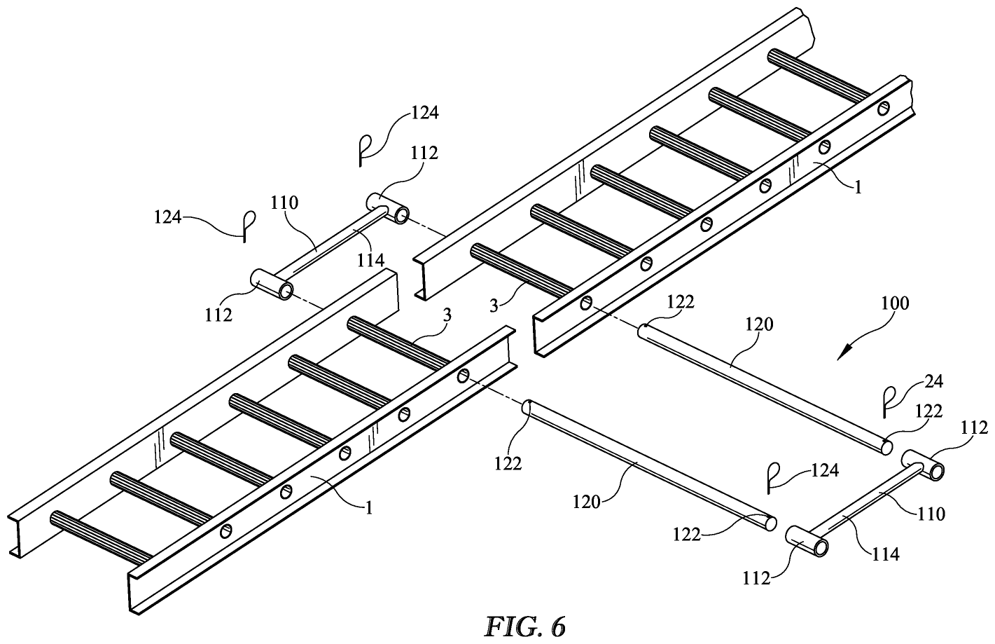

Referring now to FIGS. 6-8, and in accordance with some embodiments, an apparatus 100 for securing a pair of ladders 1 together includes a pair of end clamps 110 each having a pair of spaced sleeves 112 or tubes connected by a central member 114. Apparatus 100 further comprises a pair of rung tubes or rods 120, sized to fit through hollow rungs 3 of ladder 1. Rung tubes 120 may include an aperture 122 through each end thereof sized to accept a conventional cotter pin 124, or a clevis pin or similar fastener.

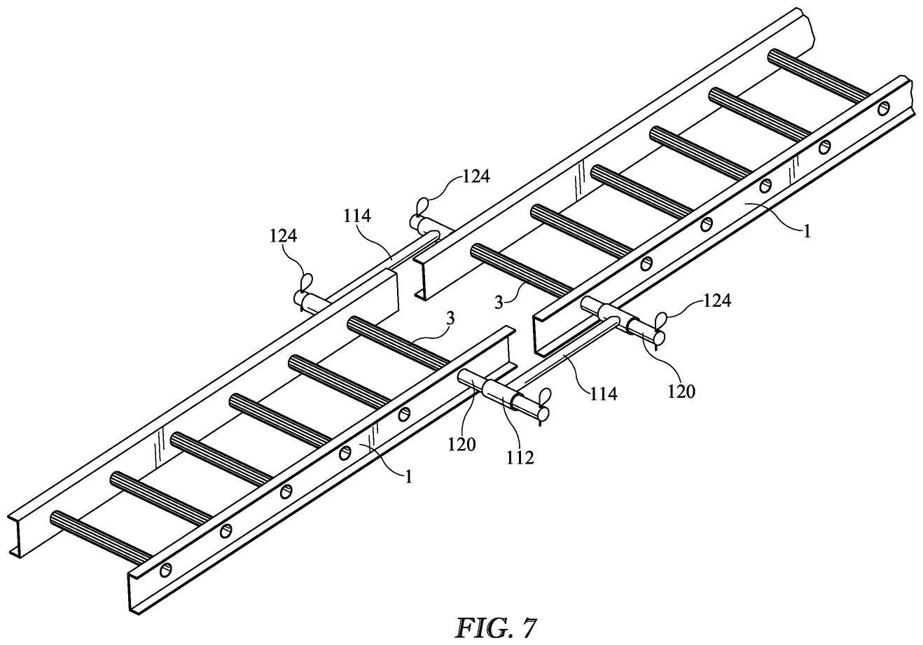

As depicted in FIG. 7 rung tubes 120 are inserted through the end rungs 3 of two ladders 1 being connected. End clamps 110 are then placed over rung tubes 120 outside ladder 1 rungs 3 so that sleeves 112 engage rung tubes 120. Pins 124 are then secured through apertures 122, thereby preventing end clamps 120 from sliding off rung tubes 110, and thus securing apparatus 100 to both ladders 1. As readily seen from FIGS. 6 and 7, apparatus 100 may be employed as a universal device to secure two ladders 1 together quickly and securely.

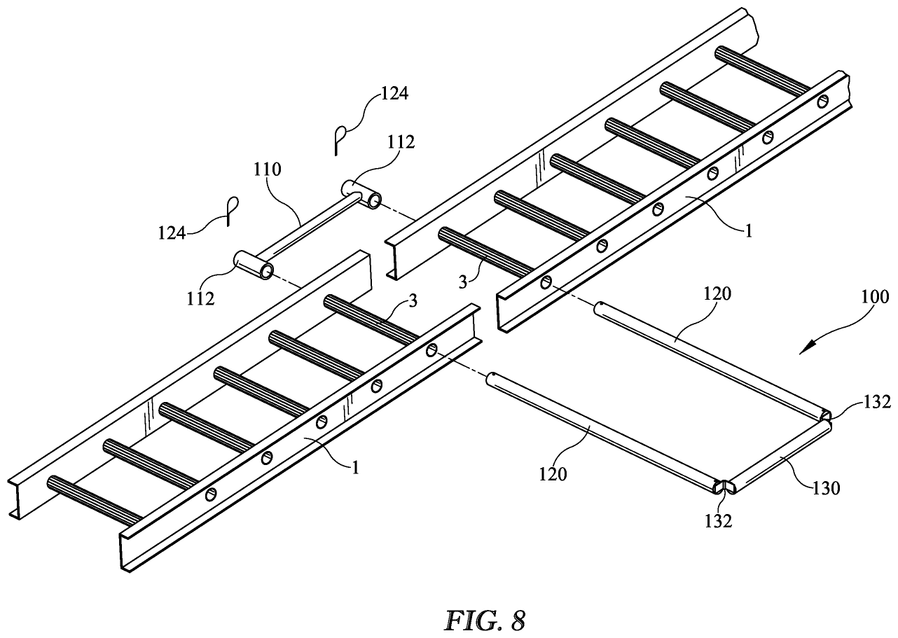

In some further aspects and embodiments as best seen in FIG. 8, apparatus 100 may include a foldable pair or rung tubes 120 that are connected by an end rod 130, having a pair of hinges 132 disposed between tubes 120 and rod 130. End rod 120 may, in some embodiments, be adjustable in length to accommodate different ladders 1. In this embodiment a single end clamp 110 may be used to quickly secure foldable rung tubes 120 in place, thereby securing ladders 1 together.

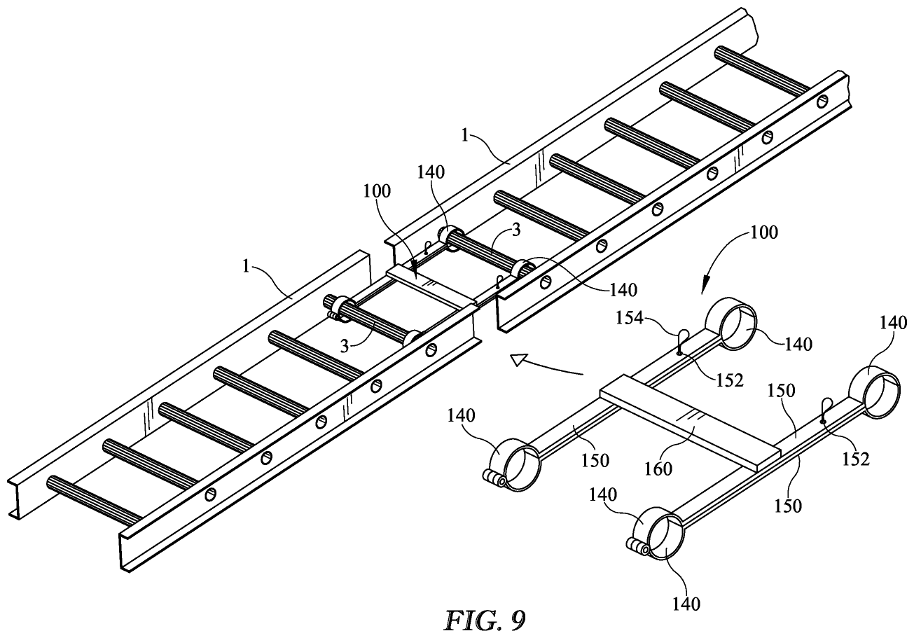

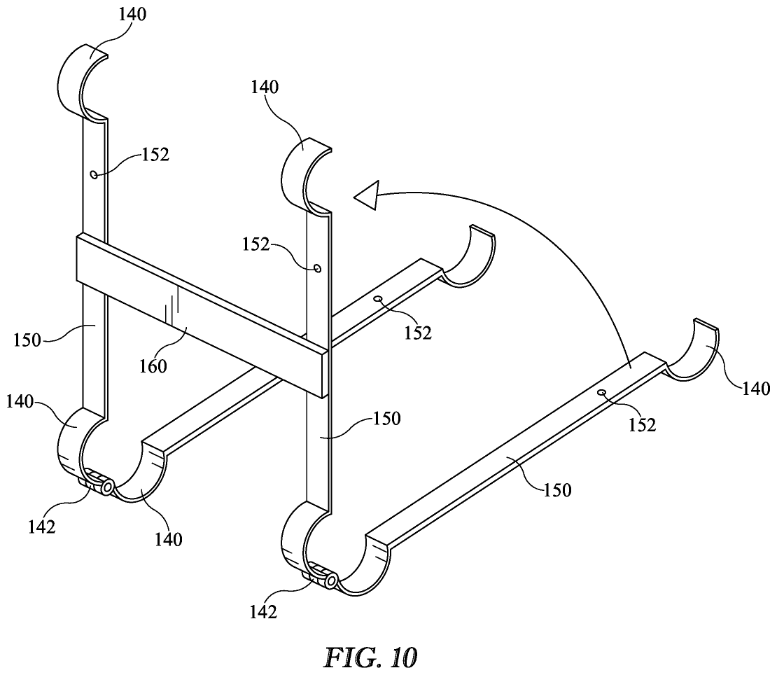

Referring now to FIGS. 9-10, and in accordance with some embodiments of the invention, an apparatus 100 is shown for securing two ladders together having two pairs of split clamps 140 for engaging ladder 1 rungs 3. Opposed pairs of split clamps 140 are connected by a pair of spaced legs 150, each having an aperture 152 therein for accepting a pin 154 or any equivalent fastener including but not limited to wing nuts, knobs, or screws to secure spaced legs 150 together. When legs 150 are closed such that clamps 140 are closed together, apertures 152 align such that pins 154 can engage each pair of apertures, thereby securing clamps 140 together.

In some embodiments a cross-member 160 is secured to a pair of spaced legs 150 to space them from each other, and prevent clamps 140 from sliding side-to-side once apparatus 100 is secured to ladder 1. In some embodiments, one pair of split clamps 140 on a first end 102 of apparatus 100 are secured together by hinges 142. As best seen in FIG. 9 the second pair of split clamps 140 simply abut each other when apparatus is positioned to engage rungs 3 of ladder 1. In operation, apparatus 100 is positioned so that one pair of spaced split clamps engages two rungs 3, and then legs 150 are closed together so that all clamps 140 engage and trap rungs 3, thereby securing two ladders 1 together.

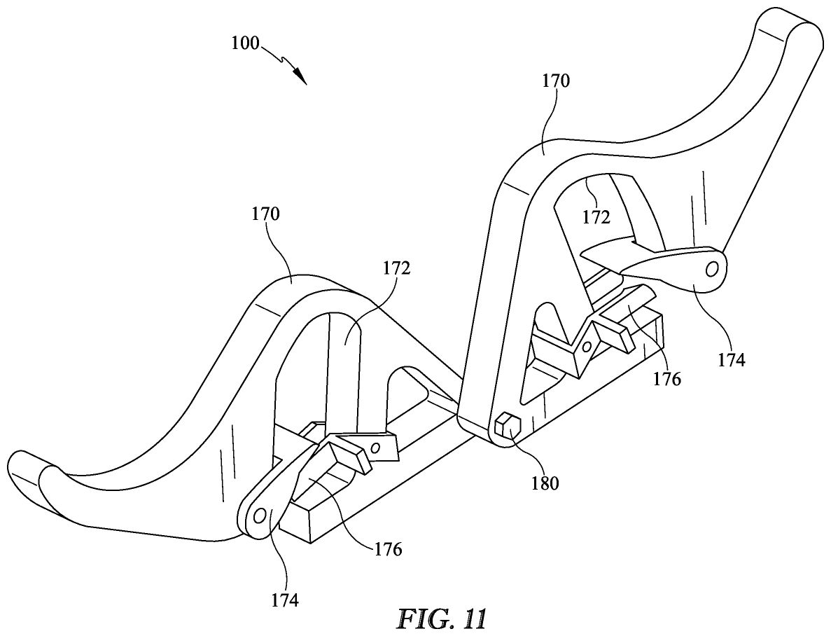

In some additional embodiments and as best depicted in FIGS. 11-13 apparatus 100 may comprise a pair of opposed ladder hooks 170 for engaging a spaced pair of ladder 1 rungs 3. Ladder hooks 170 may include a u-shaped ladder engagement portion 172 that rung 3 is engaged by, as well as a pivoting spring loaded latch 174 that is depressed or pivoted inwardly towards engagement portion 172 when rung 3 is engaged. Engagement portion 172 is large enough so that latch 174 has the ability to move back under spring tension to a stop 176, thereby capturing rung 3 in ladder hook 170.

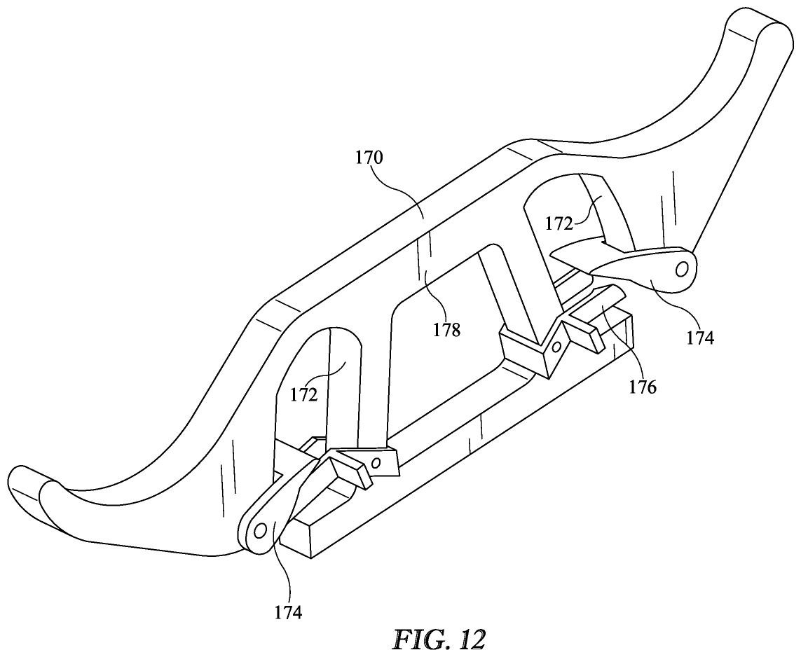

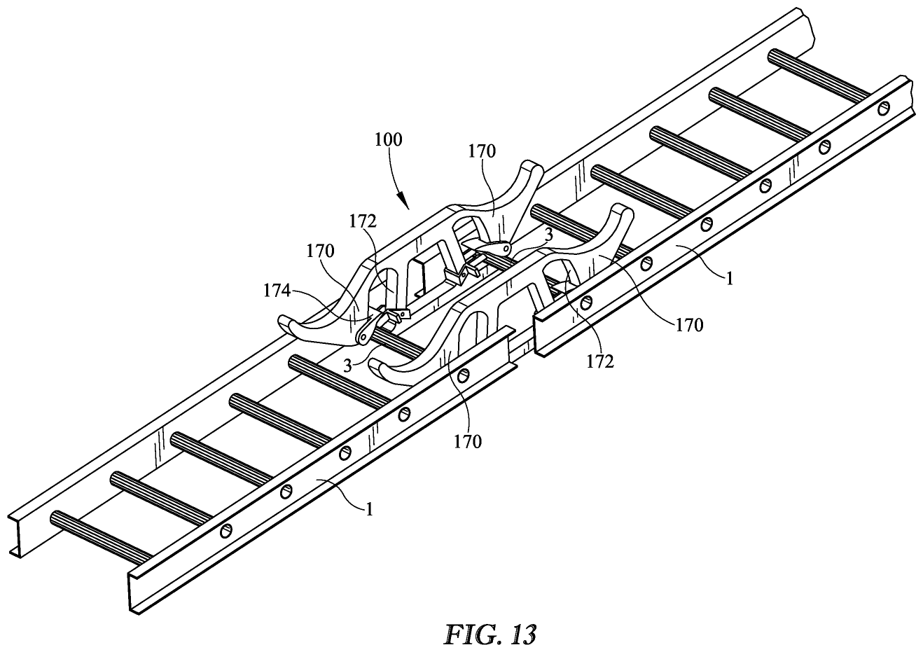

As depicted in FIG. 11 a pair of ladder hooks 170, each having an engagement portion 172 and latch 174 may be secured together via a fastener 180 or the like so that apparatus 100 can engage a pair of spaced ladder rungs 3. Alternatively, and as best depicted in FIG. 12 a pair of spaced ladder hooks 170 may be provided in a unitary apparatus 100, whereby a body portion 178 connects two opposed hooks 170. In either of the aforementioned embodiments and as best seen in FIG. 13 two pairs of opposed hooks 170 may be used to quickly and securely fasten two ladders 1 together.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

I claim:

1. A universal apparatus for securing two ladders together, each ladder having at least one hollow rung comprising:
a pair of rung tubes having first and second ends and sized to engage a hollow rung of each of said ladders; and
a pair of end clamps, each end clamp having a central member secured to a spaced pair of sleeves for engaging said rung tubes.

2. The apparatus of claim 1 wherein said rung tubes ends each have an aperture therein for accepting a pin there through.

3. A universal apparatus for securing two ladders together, each ladder having at least one hollow rung comprising:
a pair of rung tubes having first and second ends and sized to engage a hollow rung of each of said ladders, said rung tubes spaced from each other and secured to an end tube on the second ends thereof; and
an end clamp, each end clamp having a central member secured to a spaced pair of sleeves for engaging said rung tubes at the first ends thereof.

4. The apparatus of claim 3 wherein said rung tubes are secured to an end tube on the second ends thereof by a pair of hinges.

5. The apparatus of claim 3 wherein said rung tubes first ends each have an aperture therein for accepting a pin therethrough.

6. A universal apparatus for securing two ladders together, each ladder having at least one hollow rung comprising:
first and second pairs of spaced legs having first and second ends;
a first pair of split clamps secured to a first end of said first pair of legs and to a first end of said second pair of legs, said split clamps secured together by a hinge; and
a second pair of split clamps secured to a second end of said first pair of legs and to a second end of said second pair of legs; and
wherein said first and second pairs of split clamps engage two rungs of said two ladders.

7. A universal apparatus for securing two ladders together as claimed in claim 6 comprising:
at least one aperture through said first and second pairs of legs for accepting a fastener there through to secure said first and second pairs of legs together.

8. A universal apparatus for securing two ladders together, each ladder having at least one rung comprising:
a pair of spaced ladder hooks, each of said ladder hooks having a u-shaped channel for engaging and enclosing a ladder rung, and each of said u-shaped channels being closed by a spring loaded pivoting latch; and
wherein said pair of spaced hooks are secured together by a fastener whereby each hook engages said at least one rung of a different ladder.

9. A universal apparatus for securing two ladders together as claimed in claim 7 wherein said pair of spaced hooks are secured together by an integral body portion.

10. A universal apparatus for securing two ladders together as claimed in claim 7 comprising:
a second pair of spaced ladder hooks, each of said ladder hooks having a u-shaped channel for engaging and enclosing a ladder rung, and each of said u-shaped channels being closed by a spring loaded pivoting latch; and
wherein said second pair of spaced hooks are secured together by a fastener whereby each hook engages a rung of a different ladder.

11. A universal apparatus for securing two ladders together each ladder having at least one rung comprising:
four spaced ladder hooks, each of said ladder hooks having a u-shaped channel for engaging and enclosing a ladder rung, and each of said u-shaped channels being closed by a spring loaded pivoting latch; and
a pair of fasteners to secure two opposed pairs of ladder hooks together.
